(19) United States
(12) Patent Application Publication
(10) Pub. No.: US 2011/0305877 A1
(43) Pub. Date: Dec. 15, 2011

(54) Hand-Moldable Fluid Channeling Device

(76) Inventors: Dane R. Jackson, Port Matilda, PA (US); Timothy R. McMillen, Tyrone, PA (US); Daniel A. Silver, State College, PA (US); R. Douglas Evans, JR., Everett, PA (US)

(21) Appl. No.: 13/155,101

(22) Filed: Jun. 7, 2011

Related U.S. Application Data
(60) Provisional application No. 61/352,858, filed on Jun. 9, 2010.

(51) Int. Cl. B32B 3/26; B32B 3/00; B32B 15/04

(52) U.S. Cl. 428/192; 428/457; 428/332; 428/319.1

(57) ABSTRACT

The invention includes a hand-moldable fluid channeling device having a malleable metal sheet layer, a flexible polymeric material layer and a flexible adhesive layer positioned between and adjoining the malleable metal sheet layer and the flexible polymeric material layer. The invention also includes a hand-moldable fluid channeling device having a malleable metal sheet layer and a flexible polymeric material layer bonded to the malleable metal sheet layer.

### CROSS REFERENCE TO RELATED APPLICATION

This application claims the benefit of U.S. Provisional Patent Application Ser. No. 61/352,858 filed Jun. 9, 2010, which is fully incorporated herein by reference.

### BACKGROUND OF THE INVENTION

This invention is related to a hand-moldable fluid channeling device.

Various devices such as, for example, a conventional funnel, are known for directing or channeling fluids to a desired location. However, such known devices have limitations and disadvantages for particular applications or usages of a fluid channeling device. Thus, it would be advantageous to provide an improved fluid channeling device that overcomes limitations and disadvantages of known such devices.

### SUMMARY OF THE INVENTION

In one aspect, the invention includes a hand-moldable fluid channeling device having a malleable metal sheet layer, a flexible polymeric material layer and a flexible adhesive layer positioned between and adjoining the malleable metal sheet layer and the flexible polymeric material layer.

In another aspect, a hand-moldable fluid channeling device includes a malleable metal sheet layer and a flexible polymeric material layer bonded to the malleable metal sheet layer.

These and other aspects of the present invention will be more fully understood following a review of this specification and drawings.

### BRIEF DESCRIPTION OF THE DRAWINGS

FIG. 1 is a top view of a hand-moldable fluid channeling device, in accordance with an aspect of the invention.

FIG. 2 is a sectional view taken along line 2-2 of FIG. 1, in accordance with an aspect of the invention.

FIG. 3 is a sectional view taken along line 3-3 of FIG. 2, in accordance with an aspect of the invention.

FIG. 4 is a sectional view of an additional hand-moldable fluid channeling device, in accordance with an aspect of the invention.

FIG. 5 illustrates an isometric view of an additional hand-moldable fluid channeling device, in accordance with an aspect of the invention.

FIG. 6 illustrates an isometric view of an additional hand-moldable fluid channeling device, in accordance with an aspect of the invention.

FIG. 7 illustrates an isometric view of an additional hand-moldable fluid channeling device that has been shaped for use, in accordance with an aspect of the invention.

### DETAILED DESCRIPTION

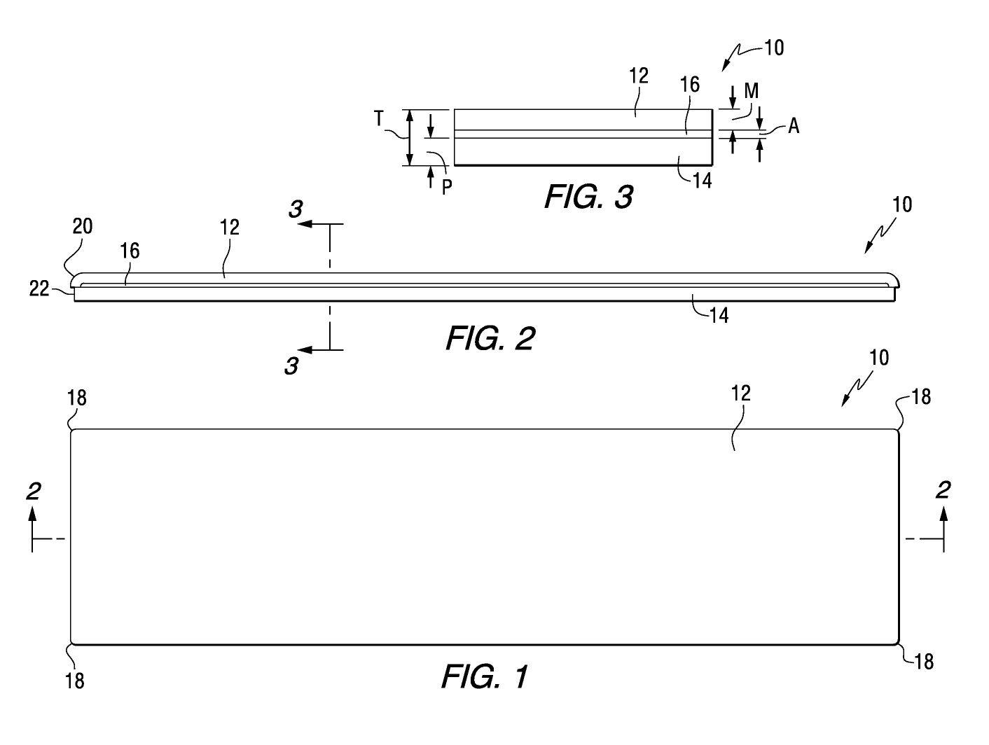

Referring to FIGS. 1-3, the invention is directed to a hand-moldable fluid channeling device 10 that can be shaped and reshaped by hand into a three-dimensional shape so as to guide fluids and free flowing solids between two locations. The device 10 once shaped will retain its shape until it is purposely reformed for storage or another usage.

In accordance with one aspect of the invention, the hand-moldable fluid channeling device 10 includes a malleable metal sheet layer 12, a flexible polymeric material layer 14 and a flexible adhesive layer 16 positioned between and adjoining the malleable metal sheet layer 12 and the flexible polymeric material layer 14.

The malleable metal sheet layer 12 may be formed of, for example, aluminum, copper, copper alloys, lead, or combinations thereof. The choice of material for forming the malleable metal sheet layer 12 is dictated by being able to be shaped and reshaped by hand and able to retain its shape for particular applications and uses of the device 10. The malleable metal sheet layer 12 may have a thickness M in the range of about 0.008 inches to about 0.038 inches. In one example, the malleable metal sheet layer 12 is formed of aluminum and has a thickness of 0.014 inches. In addition, the malleable metal sheet layer 12 may be anodized for improve scratch resistance. In addition, the anodized aluminum may be dyed or pigmented for improved visual aesthetics of the device 10.

The flexible polymeric material layer 14 may be formed of, for example, closed cell foam, films of polyolefin, polyester, nylon, natural rubber or synthetic rubber. The flexible polymeric material layer 14 may have a thickness P in the range of about 0.003 inches to about 0.188 inches. In one example, the flexible polymeric material layer 14 is a 1/16 inch thick, 4 pound/cubic foot density, closed cell polyethylene foam that is UV light resistant. In addition, the layer 14 may be pigmented for improved visual aesthetics of the device 10. In one aspect, the flexible polymeric material layer 14 is preferably resistant to most common automotive and machinery fluids such as, for example, motor oil, hydraulic oil, antifreeze, and gasoline, as well as, mild acids and corrosives and other chemicals that may be incompatible with the malleable metal sheet layer 12 side of the device 10.

The flexible adhesive layer 16 may be formed of for example, a pressure sensitive adhesive, an acrylic based pressure sensitive adhesive, rubber contact adhesive, hot melt adhesives, or a hot extruded polyolefin resin. The flexible adhesive layer 16 may have a thickness in the range of about 0.002 inches to about 0.010 inches. In one example, the flexible adhesive layer 16 may be a cross linked acrylic based pressure sensitive adhesive (PSA) that is preferably resistant to most common automotive and machinery fluids such as, for example, motor oil, hydraulic oil, and antifreeze.

In one aspect of the invention, the hand-moldable fluid channeling device 10 may have a total thickness T, i.e., a combined thickness of the malleable metal sheet layer 12, the flexible polymeric material layer 14 and the flexible adhesive layer 16 in the range of about 0.013 inches to about 0.236 inches.

In one aspect of the invention, the device 10 includes rounded corners 18. In another aspect, a perimeter edge 20 of the malleable metal sheet layer 12 is slightly turned or curved toward the flexible polymeric material layer 14 so as to form a bevel-like edge with the lower corner edge of the malleable metal sheet layer 12 covered or imbedded into the layer 14 (see, for example, FIG. 2). One advantage of this configuration is that potentially sharper corner edges of the malleable metal sheet layer 12 are covered by the softer flexible polymeric material layer 14.

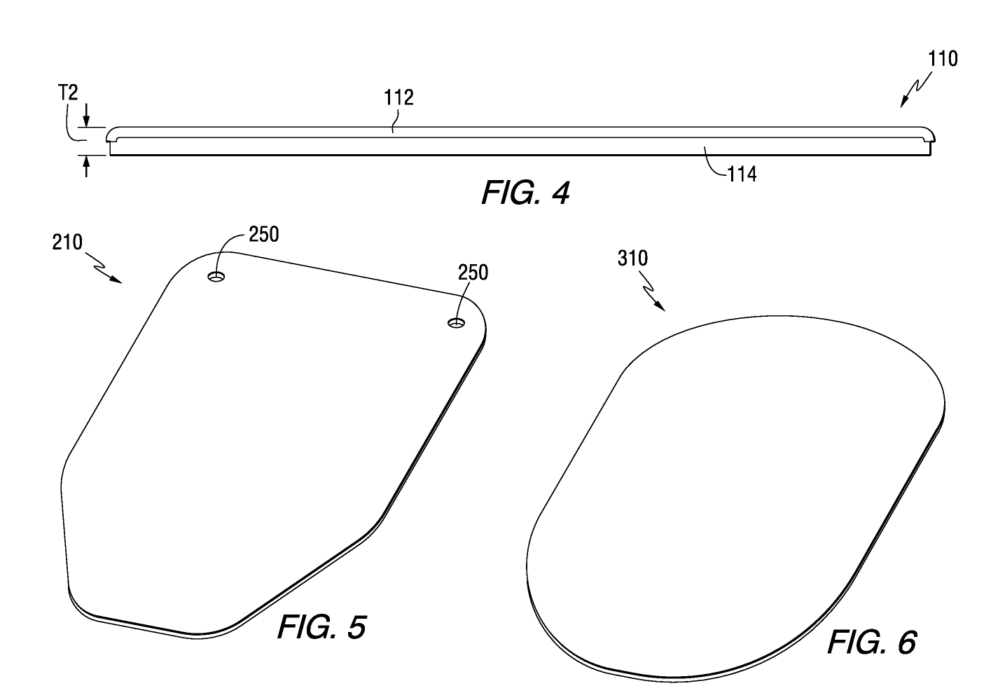

In accordance with another aspect of the invention, FIG. 4 illustrates another embodiment of a hand-moldable fluid channeling device 110. The device 110 is similar to the device 10 as illustrated, for example, in FIG. 2 but does not include the flexible adhesive layer. More specifically, the device 110 includes a malleable metal sheet layer 112 and a flexible polymeric material layer 114 that is bonded to the layer 112 without the use of a flexible adhesive material. In one aspect, the flexible polymeric material layer 114 is thermally bonded to the malleable metal sheet layer 112.

In accordance with aspects of the invention, the device 110 is otherwise similar in materials and functionality as the device 10, as described herein. The malleable metal sheet layer 112 may have a thickness in the range of about 0.008 inches to about 0.038 inches. The flexible polymeric layer 114 may have a thickness in the range of about 0.003 inches to about 0.188 inches and the device 110 may have a total thickness T2, i.e., a combined thickness of the malleable metal sheet layer 112 and the flexible polymeric material layer 114 in the range of about 0.011 inches to about 0.226 inches.

In another aspect of the invention, the hand-moldable fluid channeling device of the invention may have various shapes and configurations as desired for particular applications and usages. For example, the device 10 as illustrated, for example, in FIG. 1 may have a generally rectangular shape or configuration. As illustrated in FIG. 5, a hand-moldable fluid channeling device 210 may have a generally rectangular shape with tapered ends while FIG. 6 illustrates a hand-moldable fluid channeling device 310 that is generally oblong with rounded ends. In another aspect, as illustrated in FIG. 5, the devices may include through holes 250 so that the device may be hung on pegs during storage. Of course, it will be appreciated that various other shapes and configurations of hand-moldable fluid channeling devices may be provided in accordance with the scope of the present invention.

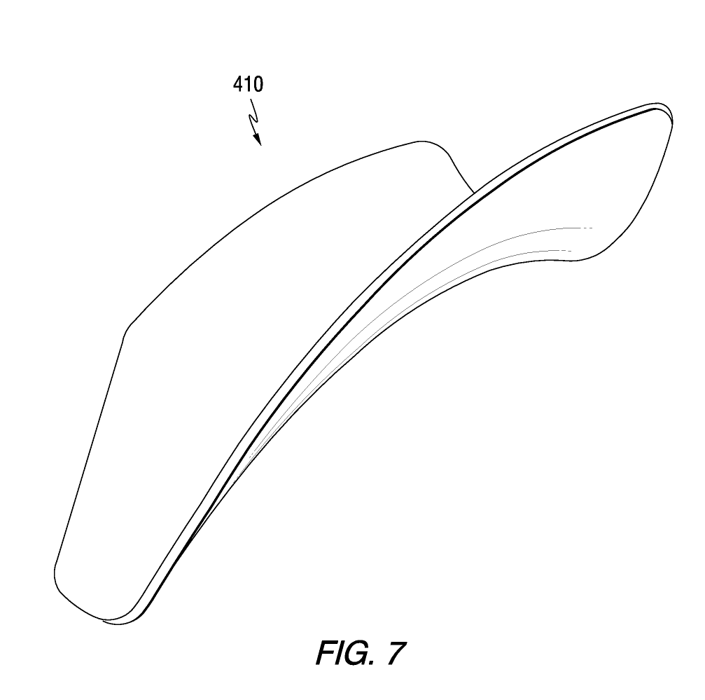

In another aspect of the invention, FIG. 7 illustrates a hand-moldable fluid channeling device 410 of the invention that has been shaped for use. It will be appreciated that the device 410 may be shaped to have various shapes and configurations as desired for particular applications and usages and that it will retain its shape due to the shape retention properties of the materials described herein to form the hand-moldable fluid channeling device.

For manufacturing the hand-moldable fluid channeling devices of the present invention, the device 10 may be die cut from a larger or continuous sheet of the malleable metal/adhesive/polymeric material laminate so that multiple units may be produced at the same time. Alternately, the device 10 may be cut out via a laser or high pressure fluid jet. During the cutting operation, the cutting tool should contact the malleable metal sheet layer 12 first so if any metal bur is produced, it is on the polymeric material layer 14 side and thus mitigated by the thickness of the polymeric material 14.

In another aspect, the device 10 may be assembled from separate die cut pieces of malleable metal sheet 10 and die cut pieces of flexible polymeric material 14 that is adhesively laminated together. In one aspect, the malleable metal sheet is die cut slightly smaller than the polymeric material, so when assembled the flexible polymeric material edges overlap the malleable metal edges as described herein.

In another aspect, the device may be branded by printing a solvent resistant ink or by physically embossing the polymeric side with light pressure with sufficient heat to selectively and permanently deform the polymeric material 14 so as to form a logo and/or alphanumeric characters.

Whereas particular embodiments of this invention have been described above for purposes of illustration, it will be evident to those skilled in the art that numerous variations of the details of the present invention may be made without departing from the invention as defined in the appended claims.

What is claimed is:

1. A hand-moldable fluid channeling device, comprising:
a malleable metal sheet layer;
a flexible polymeric material layer; and
a flexible adhesive layer positioned between and adjoining the malleable metal sheet layer and the flexible polymeric material layer.

2. The hand-moldable fluid channeling device of claim 1, wherein the malleable metal sheet layer is formed of aluminum, copper, copper alloys, lead or combinations thereof.

3. The hand-moldable fluid channeling device of claim 1, wherein the malleable metal sheet layer has a thickness in the range of about 0.008 inches to about 0.038 inches.

4. The hand-moldable fluid channeling device of claim 1, wherein the flexible polymeric material layer is formed of closed cell foam, films of polyolefin, polyester, nylon, natural rubber or synthetic rubber.

5. The hand-moldable fluid channeling device of claim 1, wherein the flexible polymeric material layer has a thickness in the range of about 0.003 inches to about 0.188 inches.

6. The hand-moldable fluid channeling device of claim 1, wherein the flexible adhesive layer is formed of a pressure sensitive adhesive, an acrylic based pressure sensitive adhesive, rubber contact adhesive, hot melt adhesive, or a hot extruded polyolefin resin.

7. The hand-moldable fluid channeling device of claim 1, wherein the flexible adhesive layer has a thickness in the range of about 0.002 inches to about 0.010 inches.

8. The hand-moldable fluid channeling device of claim 1, wherein the malleable metal sheet layer, the flexible polymeric material layer and the flexible adhesive layer have a combined thickness in the range of about 0.013 inches to about 0.236 inches.

9. The hand-moldable fluid channeling device of claim 1, wherein a perimeter edge of the malleable metal sheet layer is curved downward to form a bevel like edge.

10. A hand-moldable fluid channeling device, comprising:
a malleable metal sheet layer; and
a flexible polymeric material layer bonded to the malleable metal sheet layer.

11. The hand-moldable fluid channeling device of claim 10, wherein the malleable metal sheet layer is formed of aluminum, copper, copper alloys, lead or combinations thereof.

12. The hand-moldable fluid channeling device of claim 10, wherein the malleable metal sheet layer has a thickness in the range of about 0.008 inches to about 0.038 inches.

13. The hand-moldable fluid channeling device of claim 10, wherein the flexible polymeric material layer is formed of closed cell foam, films of polyolefin, polyester, nylon, natural rubber or synthetic rubber

14. The hand-moldable fluid channeling device of claim 10, wherein the flexible polymeric material layer has a thickness in the range of about 0.003 inches to about 0.188 inches.

15. The hand-moldable fluid channeling device of claim 10, wherein a perimeter edge of the malleable metal sheet layer is curved downward to form a bevel like edge.

16. The hand-moldable fluid channeling device of claim 10, wherein the malleable metal sheet layer and the flexible polymeric material layer have a combined thickness in the range of about 0.011 inches to about 0.226 inches.

17. The hand-moldable fluid channeling device of claim 10, wherein the flexible polymeric material layer is thermally bonded to the malleable metal sheet layer.

18. The hand-moldable fluid channeling device of claim 10, wherein the malleable metal sheet layer and the flexible polymeric material layer have rounded corners.

19. The hand-moldable fluid channeling device of claim 10, wherein the malleable metal sheet layer is hand-moldable and has shape retention properties.
